(19) United States
(12) Patent Application Publication
(10) Pub. No.: US 2011/0299554 A1
(43) Pub. Date: Dec. 8, 2011

(54) Solutions for dynamic NAT and firewall traversal

(76) Inventors: Jordi Ros-Giralt, Vilafranca del Penedes (ES); Wei Kang Tsai, Irvine, CA (US)

(21) Appl. No.: 12/927,840

(22) Filed: Nov. 26, 2010

Related U.S. Application Data
(63) Continuation-in-part of application No. 11/934,858, filed on Nov. 5, 2007, now abandoned.
(60) Provisional application No. 60/864,517, filed on Nov. 6, 2006.

(51) Int. Cl. H04J 3/22

(52) U.S. Cl. 370/469

(57) ABSTRACT

Solution methods for ensuring control and data packets to traverse network address translators (NATs) and firewalls, when a mobile terminal acquires a new (Internet Protocol) address and may move behind a new NAT/firewall are provided. These solutions form an integral part of seamless mobility and multipath packet delivery in IP networks. The solution approach decomposes the problem into downstream control-plane, downstream data-plane, and upstream data-plane sub-problems. The solution is scalable as it does not require a new routing infrastructure, except in the case of traversing a symmetric NAT, a middle box is used as a relay

### REFERENCE TO RELATED APPLICATIONS

This application is a continuation-in-part of and claims priority of co-pending U.S. patent application Ser. No. 11/934,858, filed Nov. 5, 2007 entitled “SYSTEM AND METHOD FOR SUPPORTING MOBILITY AND MULTIPATH PACKET DELIVERY IN IP COMMUNICATIONS AND COMPUTER NETWORKS ACROSS NAT AND FIREWALL BOXES,” which claims priority to Provisional Application No. 60/864,517, filed Nov. 6, 2006. The disclosures of application Ser. Nos. 11/934,858 and 60/864,517 are incorporated herein by reference.

### FIELD OF THE INVENTION

The present invention has two related fields of invention: mobility management and network convergence. More specifically, the present invention relates to methods for traversing network address translation (NAT) and firewall boxes as a host changes its Internet Protocol (IP) attachment points. These traversals are often required for supporting mobility or multipath packet delivery.

### BACKGROUND OF THE INVENTION

The present invention provides solution methods for the Dynamic NAT and Firewall (DNF) traversal problem. The DNF problem is a sub-problem of the IP mobility and multipath packet delivery (MPD) problems. First, the IP mobility problem is described.

In standard computer terminology, a host (or terminal) is a computer connected to an IP network. If a host is a server, it is also called a server terminal, or simply a server; if a host is a client terminal (as in the classic server-client model), it is also called a client terminal, or simply a client.

If a host moves to a new location, the IP address for the host must update accordingly so that packets can be routed correctly to and from the host, using the new IP address. In IP networks, a connection is identified by a tetrad (4-tuple): source IP address, source port number, destination IP address, and destination port number. Hereafter, an IP address-port pair will simply be called an AP; a source AP will be called a SAP, and a destination AP will be called a DAP. Thus, a tetrad is an ordered pair formed by a SAP and a DAP: (SAP, DAP).

In a live connection, if one endpoint moves, the routes to and from the moved endpoint have to change. The simplest way to change the routes is to change the IP address of the mobilized host (a host that changes its IP address or network attachment point). However, once the mobilized host changes its IP address, the original connection ID is also modified—recall that a connection ID is a tetrad, which is the pair (SAP, DAP); either the SAP or DAP contains a changed IP address. The IP mobility problem is that of routing packets correctly to and from a mobilized endpoint, without breaking the connection. By not breaking a connection or keeping a connection alive, it is meant that all packets of the connection at each receiving endpoint keep the original connection ID (the tetrad associated with the connection destined for the receiving endpoint) as seen by the applications running on top of the IP connection. In the computer terminology, keeping a connection alive during a mobility event is also described as being seamless.

A related problem is that of multipath packet delivery (MPD). MPD is useful if a host is able to connect via multiple IP addresses to a remote host.

MPD is intimately related to the problem of IP mobility. In a soft handover, a host moving from one network Na to another Nb, will first make a new connection in Nb before breaking the connection in Na. Once the connection in Nb has been established, the host drops the connection in Na. But between the time the host finishes establishing a connection in Nb and the time it breaks the connection in Na, the host is using both networks at the same time. Thus, in a soft handover, packets between two endpoints travel in multiple paths. It is in this sense that soft handover is a short-lived form of MPD.

It should be appreciated that, during a soft handover, a moved host has two IP addresses, one associated with the original attachment point in Na and the other associated with the new attachment point in Nb.

Another MPD scenario is that a host has multiple antennas, and is able to connect simultaneously to a remote host via multiple network interfaces. For example a smartphone might have both a Wi-Fi antenna and a 3G (3^{rd} generation cellular) antenna. Then the smartphone can communicate with a remote host via both a Wi-Fi path and a 3G path. In this scenario, a host has two distinct IP addresses, each at a distinct channel.

Thus, the problem of MPD is that of routing packets correctly between two endpoints in a single connection while one endpoint has multiple IP addresses.

Next, the problem of DNF is described. In IP networking, a NAT box serves as the boundary between two IP domains. Behind a NAT, a host uses private IP address; in front of or outside of a NAT, a host uses a public IP address. In crossing a NAT, a packet's SAP (source IP address and port number) or DAP (destination IP address and port number) is modified by the NAT. This creates a blindness problem: a host does not know the reachable IP address of its source or destination behind a NAT. In crossing a firewall, a packet is subject to deep packet inspection and filtering. Various firewall algorithms might drop packets of suspicious origin or with a suspicious header. This filtering makes it impossible for some packets to traverse a firewall. The combined problem of ensuring packets to cross a NAT and a firewall so that they reach desired destinations is called the NAT and firewall traversal problem. Since a NAT with firewall functionality presents a more challenging problem, hereafter, a NAT box is assumed to be a combined NAT-and-firewall box.

Now, the DNF problem is more than the classic NAT and firewall traversal problem. In the DNF problem, a host is mobilized, i.e., it acquires a new IP address. In addition, the mobilized host is assumed to have moved behind a new NAT box. Therefore, the problem of DNF is that of routing packets, within an IP connection, correctly to and from a host which changes its attachment point and moves behind a new NAT box, while remote endpoint of the connection might also sit behind a NAT box.

It should be appreciated that the DNF problem is a sub-problem of the IP mobility and MPD problems. However, the DNF problem does not deal with the problem of keeping a connection alive. To keep a connection alive during a mobility or MPD event, separate mechanisms have to be enacted. The DNF problem only deals with the aspect of routing packets correctly across NAT boxes between a moved host and its remote corresponding host. The aspect of keeping the connection alive is, therefore, not covered by the present invention.

There are multiple solutions to keep a connection alive during a mobility or MPD event. For example, the methods disclosed in the U.S. patent applications with Ser. Nos. 12/066,533 and 11/935,201 are applicable. Complete mobility solutions will become apparent to one skilled in the art by combining the methods disclosed in the present invention with those disclosed in these applications. In application Ser. No. 12/066,533, protocol methods are disclosed for keeping a connection alive during a mobility or MPD event, assuming all IP addresses are public (no hosts sit behind a NAT). In application Ser. No. 11/935,201, computer architectural methods are disclosed for keeping a connection alive during a mobility or MPD event.

The DNF problem is quite challenging. While the static NAT and firewall traversal problems can be solved by using standardized solutions such as STUN (simple traversal of user datagram protocol through network address translators) or a proprietary protocol such as Skype. The dynamic DNF problem is currently solved by the industry using MIP (Mobile IP) standards, or IMS (Internet Multimedia Subsystem) standards.

The MIP standard (RFC 3519) requires reconfiguring firewall boxes to open up port 434. This imposes extra burdens on network management and induces a new security glitch in the modified IP system. Due to this and other limitations of MIP, the MIP solutions have been largely abandoned by the telecommunications industry.

The popular solution, which is based on IMS, is expensive and unscalable. In essence, the IMS approach is to erect a new routing infrastructure based on link-layer identifiers of the mobile devices which roams across different networks. It should be appreciated that the existing IP routing infrastructure is designed as the primary and sufficient means to route IP packets. However, in the IMS solutions, IP packet routing has to rely on an additional mobility-specific routing infrastructure. This is wasteful and unscalable.

Therefore, scalable DNF solutions that overcome the shortcomings of MIP and at the same time require no new mobility-specific routing infrastructure are needed.

### SUMMARY OF THE INVENTION

The present invention provides a generic framework and a set of techniques to solve the dynamic NAT and firewall traversal problem as one host acquires a new IP address and moves behind a new NAT.

The DNF solutions do not require NAT and firewall boxes to be re-configured, thus making the methods non-invasive. In addition, the methods do not create new security holes or glitches that cause the overall communication system to be less secure, after deploying the solutions in accordance with the present invention.

The DNF solutions will integrate simply with other mechanisms to create complete solutions to enable seamless IP mobility and multipath packet delivery.

The DNF solution framework decomposes the DNF problem into three sub-problems: downstream control-plane (DC) problem, downstream data-plane (DD) problem, and upstream data-plane (UD) problem.

The DNF solution methods involve sending a specific sequence of special control or modified data packets between the two endpoint hosts and processing these special packets.

The DNF solutions do not require additional hardware boxes to be installed in the network infrastructure, except when symmetric NAT boxes sit in between the two end hosts. When and only if a symmetric NAT is in the path between two end hosts, the solutions require the insertion of a middle box to act as a relay.

### BRIEF DESCRIPTION OF THE DRAWINGS

The above and other objects and features in accordance with the present invention will become apparent from the following descriptions of embodiments in conjunction with the accompanying drawings, and in which:

FIG. 1 shows a possible embodiment of a mobility-supporting IP communication system having a cooperative stack (costack) inserted next to the IP layer to enable the main operations: generation of new control packets, manipulation and processing of both control and data packets.

FIG. 2 shows a possible embodiment of one method to solve the DC problem, in which a control packet is embodied into a SYN packet, which is a standard TCP (transmission control protocol) control packet for synchronization.

FIG. 3 illustrates a situation in which the method in FIG. 2 fails to traverse a NAT box and a strengthened method which emulates a new connection request more completely is also depicted, wherein the SYN packet carries no control information, which instead is piggybacked on a succeeding ACK packet.

FIG. 4 shows a complete emulation of TCP connection setup, which is used to convey control information to a remote host, in case the method in FIG. 3 also fails to traverse a NAT box.

FIG. 5 illustrates an embodiment of the inserted middle box, in which a costack module is inserted to the network layer.

### DETAILED DESCRIPTION OF THE PRESENT INVENTION

The following definitions will be used in the description of the present invention:

Terminal: a computing device with an IP address and the ability to process IP packets.

MT (Mobile Terminal) a terminal that can move from one network location to another.

CT (Corresponding Terminal) a terminal that is communicating with MT at the other end of an IP connection.

Between two endpoints of an IP connection, packets flow between two terminals, say TR1 and TR2. All packets travelling from TR1 to TR2 (or from TR2 to TR1) carry the same tetrad, one tetrad for each direction of the connection. A tetrad is a 4-tuple. The tetrad associated with packets travelling from TR1 to TR2 is consisted of (SAP_1, DAP_1), wherein SAP_1=(ipa_tr1, prt_tr1), ipa_tr1 is TR1's IP address, and prt_tr1 is TR1's TCP or UDP (user datagram protocol) port number; DAP_1=(ipa_tr2, prt_tr2), ipa_tr2 is TR2's IP address, and prt_tr2 is TR2's TCP or UDP port number. The tetrad associated with packets travelling from TR2 to TR1 is consisted of (SAP_2, DAP_2), wherein SAP_2=DAP_1, and DAP_{—}2=SAP_1. Note that the tetrad for the direction from TR1 to TR2 is the reversed form of the tetrad for the reversed direction from TR2 to TR1.

Finally, all NAT boxes are assumed to be combined NAT-and-firewall boxes.

The first step in solving the DNF problem is to reduce the DNF problem into a set of sub-problems. Assume that MT moves from network Na to network Nb. Then the DNF problem is naturally decomposed into: the downstream problem, in which packets travel from CT to MT, and the upstream problem, in which packets travel from MT to CT.

In accordance with one aspect of the present invention, to solve the DNF problem, certain control information is to be relayed from MT to CT or from CT to MT. This control information includes, but is not restricted to, new IP address of MT in network Nb, and identifiers for a live connection between MT and CT. The control information may or may not be included in every control or data packet sent between MT and CT.

First consider the downstream problem. In order for CT to send packets correctly to MT after MT has moved from network Na to network Nb, MT must inform CT of its new IP address. An obvious solution is to send control packets which contain the new IP address from MT to CT. However, the control packets might not safely reach CT as MT and CT could be separated by NAT boxes in the path from MT to CT.

Therefore, the design objective is to ensure that such control packets cross these NAT boxes. Recall that a NAT box could drop a packet due to the actions of the attached firewall. In addition, if CT sits behind a NAT, then for the control packets to reach CT, they must be destined with a reachable public IP address of CT. These issues together form the downstream control-plane (DC) problem.

After CT has correctly received the control packets from MT, CT still has to send its data packets to MT in the downstream direction. If there are NAT boxes in the path from CT to MT, then there are issues of ensuring that data packets from CT to MT survive NAT traversal and reach MT correctly. These issues together form the downstream data-plane (DD) problem.

Consider the upstream problem. Having moved from network Na to network Nb, the next step of MT is to send data packets to CT from the new IP address. Again, as CT may sit behind a NAT, packets could be dropped and might not be routed correctly if they are not destined with a reachable public address of CT. These issues together form the upstream data-plane (UD) problem.

Now, the UD problem is precisely the same as the DC problem except that the packets to be sent from MT to CT are changed from control packets to data packets. Thus, all solutions for the DC problem can be adapted to solve the UD problem.

In summary, the DNF problem is naturally decomposed into three sub-problems: DC, DD, and UD problems. Notice that there is no upstream control-plane problem: the reason is that MT is fully aware of its new IP address. Further, there are really two problems to be solved: DC and DD, as the UD problem is essentially the same as the DC problem.

In solving the DC problem, there are two cases to consider: (1) MT and CT follow a client-server model in which CT is the server and MT is the client, or (2) MT and CT do not follow a client-server model between them. The first case will be referred to as DC1, and the second case will be referred to as DC2.

Methods for Solving the DC1 Problem:

A method for solving the DC1 problem works as follows: MT piggybacks control information (more specifically, information identifying the connection, data needed by CT to reach MT in network Nb, etc.) onto control packets that imitate the request for a new connection setup with server CT. These control packets will survive NAT traversal and firewall filtering since by the client-server relationship, CT is a server and MT possessed a reachable public IP address of CT to begin with. Since client MT was able to establish a connection to server CT in the original network Na, it should continue to be able to do so in network Nb.

These control packets are only intended for solving the DC1 problem. An interception technique must be deployed at CT to intercept these control packets, to process them and to drop them so that no actual connection is established by the upper layer protocols or applications. A possible embodiment (while not the only one) of this interception technique is to place a cooperative stack at the network layer in CT. FIG. 1 shows a possible embodiment 100 of a DNF solution system. A cooperative stack 102 (called costack) is inserted next to the IP layer in both MT and CT to perform three main operations: generation of control packets, and manipulation and processing of existing control and data packets.

It should be noted that if MT is only aware of a private IP address at network Nb, the new private IP address is quite useless for CT to route packets correctly to MT. However, since these control packets will reach CT—in the process, they will punch a hole in the NAT box shielding MT. CT can look up the tetrad of a received control packet and obtain a reachable public IP address of MT, which is the source IP address in the tetrad.

While the above description of the solution methods for DC1 is generic, the methods can be specialized. In what follows, the new connection request is specialized to a TCP connection request.

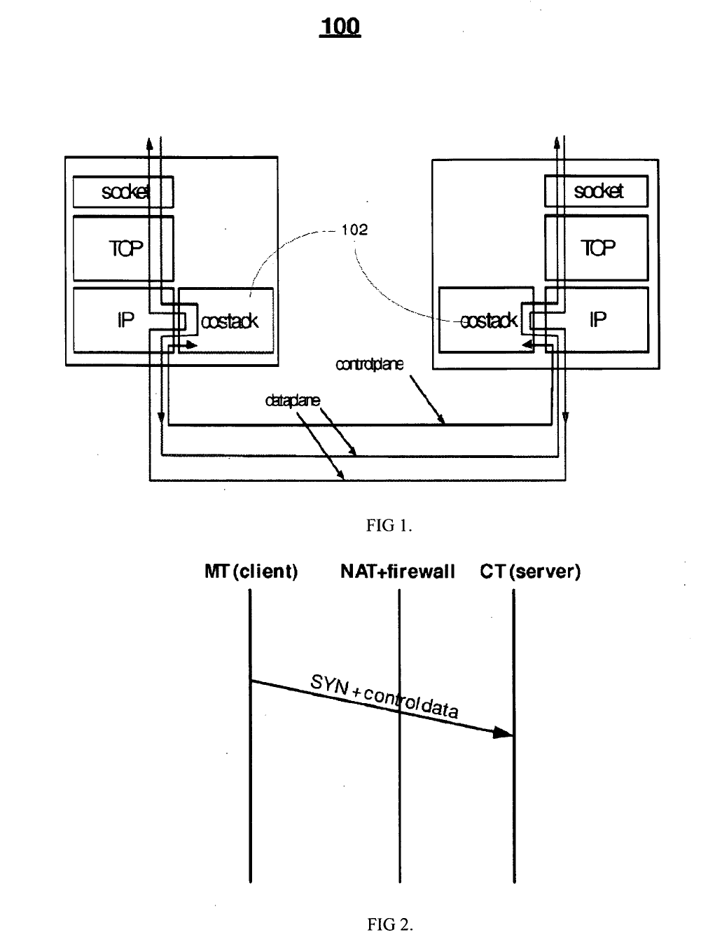

By using TCP initialization 3-way handshake, the control information is piggybacked in a number of ways. It can be piggybacked either onto a SYN packet, or an ACK (TCP acknowledge) packet. In the TCP connection request, the destination port number of the existing connection is used as the destination port number. FIG. 2 shows a method called DC1-1, wherein MT sends a specialized TCP SYN packet to CT, with control information included in the payload.

Method DC1-1 may not work as some high-end firewalls may decide to drop the specialized SYN packet as it carries nonzero payload. While the TCP standard does not prohibit SYN packets to carry a payload, most applications do not exercise this option. A high-end firewall may consider the specialized SYN packet to be suspicious and may decide to drop it.

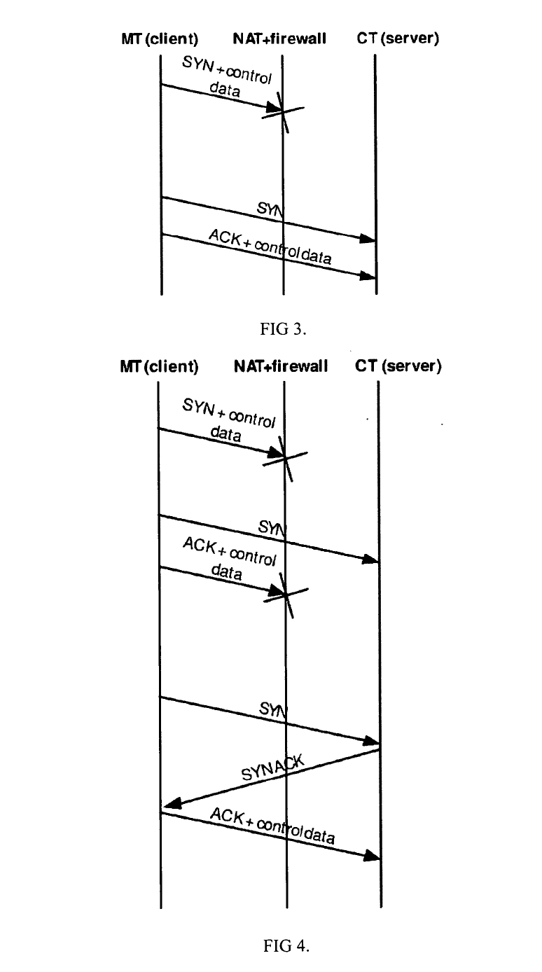

To deal with this problem, method DC1-2 may be used. In method DC1-2, MT first generate and send a TCP SYN packet with zero payloads to CT, and subsequently MT generates and send a TCP ACK packet with control information included in the payload to CT, as shown in FIG. 3. FIG. 3 also depicts a time sequence in which method DC1-1 failed as the specialized SYN packet was dropped by a firewall.

Still, method DC1-2 may fail. Then method DC1-3 may be applied. In method DC1-3, MT first sends a TCP SYN packet with zero payload, and wait for CT server to reply to MT with a SYNACK (SYN acknowledgment) packet. Then after receiving the AYNACK packet from CT, MT sends a specialized TCP ACK packet with control information included in the payload to CT. Note that method DC1-3 emulates a complete TCP three-way handshake. Method DC1-3 is depicted in FIG. 4.

Notice that similar techniques like DC1-1, DC1-2, and DC1-3 can be used in any other connection-oriented transport layer protocols that use 3-way handshake for setup.

Methods for Solving the DC2 Problem:

In the DC2 problem, MT and CT do not follow a client-server model. Thus, methods DC1-1, DC-2, and DC1-3 do not apply, as CT does not play the role of a server. To solve this problem, NAT hole-punching will play a critical role.

The DC2 problem can be further decomposed into 2 sub-cases: (1) the NAT shielding CT being non-symmetric, and (2) the NAT shielding CT being symmetric. In crossing a NAT box from inside, the SAP (source IP address and port number) of a packet is mapped into a different SAP. In crossing a NAT from outside, the DAP (destination IP address and port number) of a packet is mapped into a different DAR. In a symmetric NAT, the mapping depends on both source and destination of a packet. In a non-symmetric NAT, the mapping depends only on the source, and is independent on the destination of a packet.

First consider the case when the NAT on the CT side is non-symmetric. In crossing this NAT from CT toward MT, since the mapping of SAPs does not depend on the destination IP address (the IP address of MT), the IP address of CT as seen by MT will not change, even after MT changes its IP address. Therefore, the IP address as seen by MT when MT was in network Na will still serve as a reachable public IP address. Hence, method CD2-NS works as follows: MT builds a control packet using the previous DAP (destination IP address and port number) when it was communicating with CT in network Na, but changes its source IP address to be the new IP address in network Nb. On this packet, MT inserts control information into the packet and sends it to CT.

For the case of symmetric NAT at the CT side, two methods are available. The first method requires a middle box (MB), and the second method requires that MT and CT to be in a soft handover. The first method will be called DC2-MB, and second method will be called DC2-SH.

In method DC2-MB, a third box (a middle box or MB) outside network Na is used to intercept control packets sent by MT to CT and change their SAP (source IP address and port number) into the old SAP that MT used in the past to communicate with CT when MT was in network Na. The control information is included in the specialized control packets sent from MT to CT.

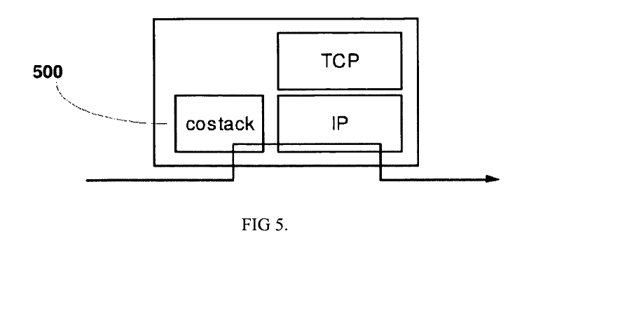

One way to implement the MB needed in method DC2-MB is to include a packet-intercepting cooperative stack (costack). The structure of a middle box showing the deployment of a costack is depicted in FIG. 5. In FIG. 5, a costack module 500 at the IP layer in the middle box is responsible for intercepting packets, modifying the SAP in the intercepted packets, and forwarding the modified packets.

It should be appreciated that method DC2-MB can be easily implemented using the concept of c-forwarding, as described in the U.S. patent application Ser. No. 12/066,533.

In method DC2-SH, MT and CT are assumed to be engaged in a soft handover, and further, MT is aware of its newly reachable public IP address in network Nb. In this method, CT punches a new hole in the NAT on the CT side by sending a control packet to MT in network Nb. This hole-punching is to allow (both control and data) packets from MT to traverse the NAT on the CT side. To execute the new hole-punching, CT needs to use the newly reachable public IP address of MT in network Nb as the destination. This new address is sent to CT via an existing channel. Recall that in DC2-SH, MT and CT are engaged in a soft-handover—the original communication channel between MT in network Na and CT is still alive.

Thus, in method DC2-SH, MT first sends its newly reachable public IP address in network Nb to CT via the existing channel from MT in network Na to CT, using a special control packet. This special control packet may also include other control information that MT needs to send to CT. Then CT sends to MT a special control packet destined with the newly reachable public IP address of MT in network Nb.

Methods for Solving the DD Problem:

Once CT has received the control information and is aware that MT is located in a different network Nb, it needs to send data packets to reach MT at its new location. Such packets in general may also need to traverse a NAT on the side of MT.

If methods DC1-1, DC1-2, DC1-3, or DC2-NS was used to send a control packet from MT to CT, then the sending of the control packets from MT to CT has already forced the punching of a hole in the NAT on the MT side. Thus, CT sends packets to MT by reversing the tetrad (by swapping SAP for DAP; DAP for SAP) found in a control packet CT received from MT. These packets with the reversed tetrad will traverse the NAT on MT side without any problems. If method DC2-SH was used for the DC problem, then CT had already sent a control packet to MT using the newly reachable public IP address of MT in network Nb. Then CT can continue to use the same tetrad to send data packets to MT. This method is called DD-1.

If method DC2-MB was used to send control information from MT to CT, then a similar method as DC2-MB can be used to solve the DD problem. In method DD-MB, CT sends its data packets destined to MT via the middle box MB (the same middle box used to solve the DC problem in method DC2-MB). Recall that in DC2-MB, MT sent control packets to MB. This action punched a hole in the NAT on the MT side, and MB has available the tetrad in a hole-punching control packet from MT to MB. Then via a mechanism in MB that intercepts packets from CT, MB modifies the tetrads in the data packets and forward the modified packets to MT. The new tetrad in a forwarded packet is obtained by reversing the tetrad (by swapping SAP for DAP; DAP for SAP) contained in an original control packet sent from MT to MB, according to DC2-MB. Thus, the reversed tetrad will enable these forwarded packets (originally from CT) to safely traverse the NAT on the MT side. The tetrad swapping (or modification) and packet forwarding can be implemented via the technique of c-forwarding disclosed in the U.S. patent application Ser. No. 12/066,533.

It should be appreciated that a slightly modified version of DC2-MB is also possible wherein the middle box used for DC2-MB and DD-MB are not the same box. In addition, the mechanism to intercept packets, to modify tetrads in packets, and to forward the modified packets, can be implemented via methods other than the c-forwarding methods described in the U.S. patent application Ser. No. 12/066,533.

In sum, methods DC1-1, DC1-2, DC1-3, DC2-NS, DC2-MB, DC2-SH, DD-1, and DD-MB solve the DC and DD problems. Further, since UD problem is essentially the same as the DC problem, these methods together for the DC problem can be simply adapted to solve the UD problem.

Finally, a possible embodiment and setup of the present invention is provided in FIG. 1. Each terminal (MT and CT) and each middle box (MB) implements a cooperative stack (costack) module 102. Costack 102 is responsible for generating, intercepting and processing the packets described in the methods of the present invention to solve the DC, DD and UD problems. In addition, costack 102 is responsible for implementing the c-forwarding operations. The c-forwarding operations modify tetrads and forward packets so that a connection is kept alive or seamless in a mobility or MPD event, according to the U.S. patent application Ser. No. 12/066,533.

What is claimed is:

1. A method to provide solutions for dynamic network translation and firewall traversal (DNF) problem, as part of an overall mobility and multipath packet delivery scheme for IP (Internet Protocol) networks, the method comprising:
partitioning the DNF problem into:
a) downstream control-plane (DC) problem;
b) downstream data-plane (DD) problem;
c) upstream data-plane (UD) problem;
wherein a mobile terminal (MT) acquires a new IP address, which may be public or private, and may move behind a new NAT (network translation) box, and MT is communicating with a corresponding terminal (CT); the solutions perform network layer and transport layer transformation via a packet interception technique; control information to be sent between MT and CT includes a new IP address of MT and identifiers for a live IP connection between MT and CT.

2. The method of claim 1, wherein the solutions for the DC problem includes:
MT sending control packets to CT as if a new connection is requested to be set up between MT as a client and CT as a server; control information is included in the payload of some of the control packets.

3. The method of claim 2 wherein the MT first sends a transmission control protocol (TCP) synchronize (SYN) packet to CT.

4. The method of claim 3, further comprising:
a) the TCP ACK packet is sent from MT to CT after MT receives a TCP SYN acknowledgment packet from CT;
b) intercepting and dropping the TCP control packets at CT so that no actual new TCP connection is set up;
c) MT inserting control information in the payload of one of the control packets sent from MT.

5. The method of claim 1, wherein the solutions for the DC problem includes:
MT sending a control packet to CT using CT's IP address, known to MT prior to MT acquiring the new IP address, as the destination;
inserting the control information into said control packet.

6. The method of claim 1, wherein the solutions for the DC problem includes:
MT sending a control packet to a middle box (MB);
wherein said control packet may include control information;
wherein said control packet is intercepted in the network layer in MB, and the source IP address and source port number of said packet are modified into the source IP address and source port number of MT, prior to MT's acquisition of the new IP address;
wherein said modified packet is then forwarded to CT, using the using CT's IP address, known to MT prior to MT acquiring the new IP address, as the destination.

7. The method of claim 1, wherein the solutions for the DC problem includes:
MT sending to CT a control packet, which carries the new public IP address of MT, using MT's IP address prior to its acquisition of the new IP address as the source IP address;
CT, upon receiving said control packet, sending a control packet to MT using MT's new public IP address.

8. The method of claim 1, wherein the solutions for the DD problem includes:
CT sending packets to MT by reversing the tetrad (by swapping source IP address for destination IP address, and swapping source port number for destination port number) found in a prior control packet CT received from MT in solving solve the DC problem.

9. The method of claim 1, wherein the solutions for the DD problem includes:
CT sending its data packets destined to MT via a middle box MB;
MB intercepting the data packets from CT and modifying the tetrads into a reversed tetrad (by swapping source IP address for destination IP address, and swapping source port number for destination port number) found in a prior control packet sent from MT to MB in solving the DC problem.

10. The method of claim 1, wherein the solutions for the UD problem includes:
MT sending its data packets to CT using the methods of claims 5-7, except MT sending data packets instead of control packets to CT.
